(19) United States
(12) Patent Application Publication
(10) Pub. No.: US 2024/0113488 A1
(43) Pub. Date: Apr. 4, 2024

(54) SUPPRESSION OF UNDESIRED WAVELENGTHS IN LASER LIGHT

(71) Applicant: NLIGHT, INC., Camas, WA (US)

(72) Inventors: Scott R. Karlsen, Camas, WA (US); Aaron BROWN, Camas, WA (US); Jay SMALL, Camas, WA (US); Stefano ORIGLIA, Torino (IT); Andrea BRAGLIA, Torino (IT)

(73) Assignee: NLIGHT, INC., Camas, WA (US)

(21) Appl. No.: 18/275,604

(22) PCT Filed: Aug. 6, 2021
(86) PCT No.: PCT/US2021/045107

§ 371 Date: Aug. 2, 2023

Related U.S. Application Data
(60) Provisional application No. 63/158,272, filed on Mar. 8, 2021.

(51) Int. Cl. H01S 3/00; G02B 5/26

(52) U.S. Cl. CPC H01S 3/0078; G02B 5/26; G02B 27/30

(57) ABSTRACT

Some embodiments may include an apparatus usable in a laser system. The apparatus may include at least one optical filter to receive a laser beam or laser light along a first axis, the laser beam or laser light generated by the laser system, wherein the at least one optical filter is configured to reflect one of light having a selected wavelength or a remainder of the laser light along a second axis that is non-parallel with the first axis and pass the other of the light having the selected wavelength or the remainder along a third axis that is parallel to the first axis. Other embodiments may be disclosed and/or claimed.

### PRIORITY

The present application is a National Phase entry under 35 U.S.C. § 371 of International Application No. PCT/US2021/045107, filed on Aug. 6, 2021, which claims priority to U.S. Provisional Application No. 63/158,272 filed on Mar. 8, 2021, entitled POST LASER SUPPRESSION OF UNDESIRED WAVELENGTHS, the entire contents of these applications are incorporated herein by reference in their entirety.

### TECHNICAL FIELD

The present disclosure relates to laser systems.

### BACKGROUND

Fiber lasers are widely used in industrial processes (e.g., cutting, welding, cladding, heat treatment, etc.) In some fiber lasers, the optical gain medium includes one or more active optical fibers with cores doped with rare-earth element(s). The rare-earth element(s) may be optically excited (“pumped”) with light from one or more semiconductor laser sources. There is great demand for high power and high efficiency diode lasers, the former for power scaling and price reduction (measured in $/Watt) and the latter for reduced energy consumption and extended lifetime.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1 illustrates a schematic diagram of an optical filter to receive laser light to reflect light having a selected wavelength along a different axis than the laser light is received, according to various embodiments.

FIG. 2 illustrates a schematic diagram of a pair of optical wedges to receive laser light and to reflect light having a selected wavelength along a different axis than the laser light is received, according to various embodiments.

FIG. 3 illustrates a schematic diagram of an optical filter to receive laser light and to pass light having a selected wavelength and to reflect a remainder of the laser light along a different axis than the laser light is received, according to various embodiments.

FIG. 4 illustrates a schematic diagram of an endcap to receive laser light in which an output surface reflects light having a selected wavelength along a different axis than the laser light is received, according to various embodiments.

FIG. 5 illustrates a top view of a collimation assembly including a window to receive laser light to reflect light having a selected wavelength along a different axis than the laser light is received, according to various embodiments.

FIG. 6A illustrates a sectional view of a removably attachable accessory for post laser suppression of undesired wavelengths in a laser system, according to various embodiments.

FIG. 6B illustrates an isometric view of the removably attachable accessory of FIG. 6A.

FIG. 7A illustrates a sectional view of a collimation assembly for post laser suppression of undesired wavelengths in a laser system, according to various embodiments.

FIG. 7B illustrates a sectional view of another collimation assembly for post laser suppression of undesired wavelengths in a laser system, according to various embodiments.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above.” “below.” “upper,” “lower,” and the like. These terms are used for convenient description, but do not imply any particular spatial orientation.

Under various conditions, fiber lasers may generate undesirable wavelengths (e.g., wavelengths in the Raman band associated with Yb fiber lasers, or other selected wavelengths). One Raman band of particular concern may include wavelengths in the 1100-1150 nm range. This additional wavelength content can create downstream chromatic issues with optics or at the workpiece. Additionally, the unwanted spectral content may create problems for emerging process-sensing schemes that collect reflected light from the workpiece.

Raman generation may increase with delivery fiber length, laser power and/or with decreasing delivery fiber core size. In some applications, a maximum Raman content of 10% of the overall power of the laser is acceptable. However, certain applications may benefit from a Raman content of only a fraction of a percent of the overall laser power. Although the natural distribution of Raman content for higher power single mode lasers may include lasers with ˜2% Raman content, a reliable, readily reproducible method of providing laser light with low Raman content may allow increases in delivery fiber length, laser power and/or with decreasing delivery fiber core size and/or may be suitable for applications that can benefit from Raman content of less than ˜2%.

In some embodiments, an optical filter to redirect undesired wavelengths (such as Raman content) out of a primary light path may be used in a laser system. In various embodiments, the optical filter may have a coating arranged to optically process a selected wavelength range. Redirection of light having the selected wavelength may be via transmissive or reflective approaches. In various embodiments, reflection of the Raman wavelengths (or other selected wavelengths) may be along a different axis than the laser light is received by the optical filter, which may avoid further amplification that can lead to undesirable laser performance or destruction results.

Some embodiments may provide an optical filter utilizing an initial air to optical interface, such as the delivery fiber endcap of the optical fiber (e.g., the coating may be applied to an output face of the delivery fiber endcap), or a cleaved fiber face in embodiments without the fiber endcap (the coating may be applied to the output face of the cleaved fiber). However, if the output face is planar and is located orthogonally to the optical axis of the received laser light, the filtered light may be reflected back into the fiber core (due to the alignment of the output face and the short distance to the fiber aperture). Therefore, various embodiments may provide the coating downstream of the initial air to optical interface, e.g., in a collimator and/or an exit aperture of the collimator.

In embodiments in which an initial air to optical interface is utilized to provide an optical filter, a coating may be applied to an output face that is not located in a plane that is located orthogonally to the optical axis (e.g., a tilted optical face or a non-planar optical face to reflect the light having the undesired wavelengths along an axis that is different than an axis along which the laser light is received by the initial air to optical interface).

In various embodiments, the optical filter is provided by adding a window to a laser system. The window may be fixably located in a collimator, or part of an accessory that removably attaches to the collimator (or some other component of a laser system). In embodiments utilizing an accessory, the optical filter may be interchangeable with a different optical filter (for a different selected wavelength) and/or a dust shield (in which the laser light is not optically processed), depending on application requirements. In various embodiments, the window may be tilted ˜1 degree with respect to a plane that is orthogonal to an optical axis of the collimator or an axis on which the laser light is received.

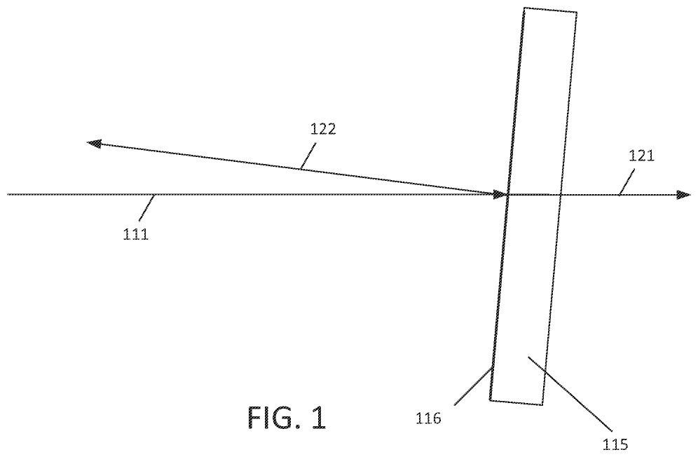

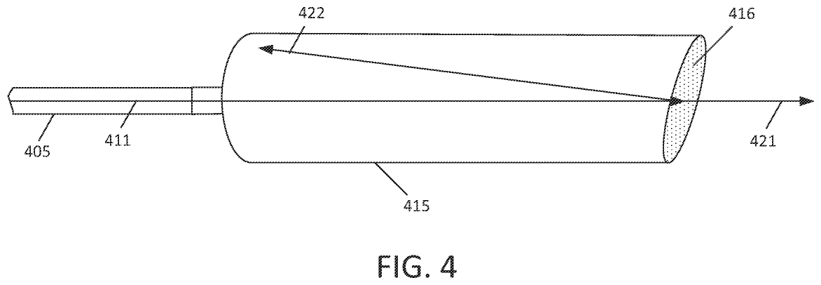

FIG. 1 illustrates a schematic diagram of an optical filter 115 to receive laser light 111 to reflect light 122 having a selected wavelength along a different axis than the laser light 111 is received, according to various embodiments. In this example, the optical filter 115 reflects light 122 having a selected wavelength (e.g., Raman light, stimulated Raman scattering, or Brillion scattering, or other undesired content) from the laser light 111 and passes a remainder 121 of the received laser light 111 (the remainder 121 may include wavelengths in the 1060-1080 nm range). A laser source (not shown) for the laser light 111 may be an optical fiber (e.g., a fiber laser) or any other optical medium of any other type of laser system. In this embodiment, the optical filter 115 may be a free space optic located downstream of an initial air to optical interface of the laser system, e.g., downstream of an endcap of a distal end of a fiber laser (or downstream of an output face of an optical fiber in the case of a fiber laser without an endcap). In other embodiments, an optical filter may be incorporated into an initial air to optical interface of a laser system (FIG. 4 shows such an example, in which the optical filter 415 is part of an endcap of a fiber laser).

Referring again to FIG. 1, laser light 111 is received over a first axis and the light 122 having the selected wavelength is reflected over a second axis that is non-parallel with the first axis. The filtered light 121 is transmitted over a third axis that may be parallel with the first axis.

In various embodiments, a surface 116 of the optical filter 115 is arranged to reflect the light 122 along the second axis. In various embodiments, the surface 116 may be located in a plane that intersects a plane that is orthogonal to the first axis. In various embodiments, the plane in which the surface 116 is located may be tilted some amount (e.g., ˜1 degree) with respect to the plane that is orthogonal to the first axis. The surface 116 may also include a Raman coating or some other coating arranged to reflect a selected wavelength in the case that the undesired wavelength is in some other wavelength band than the Raman band.

In various embodiments, the surface 116 may have any treatment, now known or later developed, that reflects the undesired wavelength. A coating is one example of a treatment that may be applied to the surface 116 that, together with the orientation of the surface 116 in the plane as discussed above, reflects the undesired wavelength along the second axis. In the present embodiment, the surface 116 is planar. However, this is not required—in other examples, a reflecting surface of an optical filter may be non-planar.

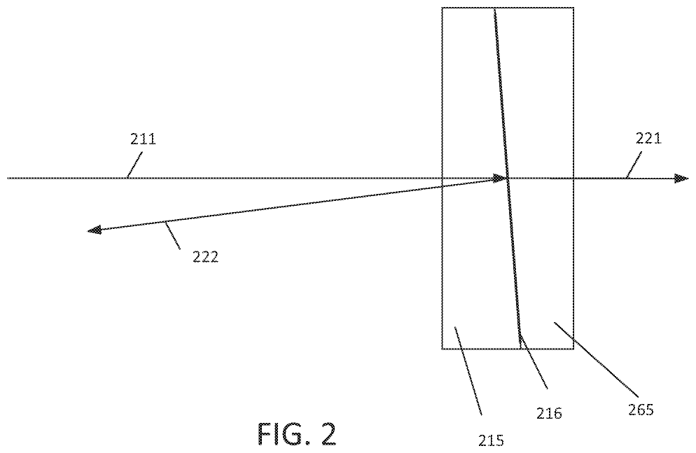

FIG. 2 illustrates a schematic diagram of a pair of optical wedges 215 and 265 to receive laser light 211 and to reflect light 222 having a selected wavelength along a different axis than the laser light 211 is received. The received laser light 211 may be similar in any respect to the received laser light 11 (FIG. 1). The second axis may be similar in any respect to the second axis of the reflected light 122 (FIG. 1). In this example, the surface 216 is located on a sloped face of one of the optical wedges 215 and 265 or on both sloped faces. The remaining light 221 may travel along a third axis similar in any respect to the third axis described with respect to FIG. 1.

Referring again to FIG. 2, one of the sloped surfaces may be located in a plane that is tilted with respect to a plane that is orthogonal to the first axis, e.g., similar to the tilt of the plane along with the surface 116 (FIG. 1) is arranged. The sloped surface(s) may have a coating, or any other treatment similar to any treatments discussed with respect to FIG. 1.

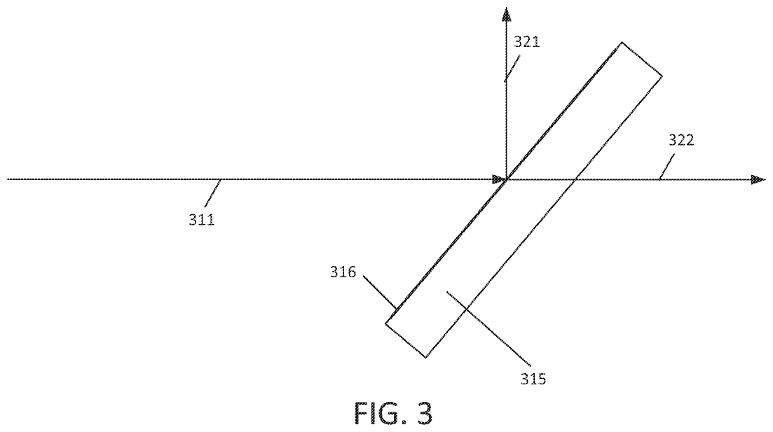

FIG. 3 illustrates a schematic diagram of an optical filter 315 to receive laser light 311 and to pass light 322 having a selected wavelength and to reflect a remainder 321 of the laser light 311 along a different axis than the laser light 311 is received, according to various embodiments. The laser light 311 may be similar in any respect to the laser light 111 (FIG. 1)

In this embodiment, the optical filter 315 may be a partial reflector arranged to pass the light 322 having the selected wavelength, and reflect the remainder 321 of the light to a next optical component of the laser system (not shown). The undesired light 322 may be output along a second axis that may be parallel with respect to the first axis. The reflected light 321 may be reflected along a third axis that may be different than the first axis, e.g., non-parallel with the first axis.

The surface 315 may include a treatment that may be similar to any treatment described herein, e.g., similar to the treatments described with respect to FIG. 1. However, the treatment of the surface 315 may be arranged to pass the light 322 having the selected wavelength rather than to reflect it. In this example, the optical filter 315 is a partial reflector in which a reflective surface is located on the side on which the laser light 311 is received, but in other examples the reflective surface may be located on the other side of the optical filter 315.

FIG. 4 illustrates a schematic diagram of an endcap 415 to receive laser light 411 in which an output surface 416 of the endcap 415 reflects light 422 having a selected wavelength along a different axis than the laser light 411 is received, according to various embodiments. In this embodiment, the endcap 415 is located at a distal end of a fiber laser. An input side of the endcap 415 may be fused to a distal end of the optical fiber 405.

The light 422 having the selected wavelength may be similar to the light 111 (FIG. 1) in any respect, and the remainder 421 may be similar to the remainder 121 (FIG. 1) in any respect. The light 422 may be reflected along a second axis that may be similar in any respect to the second axis described with respect to FIG. 1, and the remainder 421 may travel along a third axis that may be similar in any respect to the third axis described with respect to FIG. 1.

A surface 416 may be provided on an output face of the endcap 415. The surface 416 may be similar in any respect to the surface 216 provided on the sloped face of the optical wedge 215 of FIG. 2. For example, the surface 416 may be located in a plane that intersects a plane that is orthogonal to the first axis (e.g., the surface 416 may be tilted, as illustrated). In some embodiments, the amount of tilt may be ˜1 degree or some other amount that may depend on a distance between the output face of the optical fiber 405 and the output face of the endcap 415. The shorter the distance the greater the tilt, which may prevent the reflected light 422 from entering a core of the optical fiber 405 (some embodiments may allow the reflected light 422 to enter a cladding of the optical fiber 405).

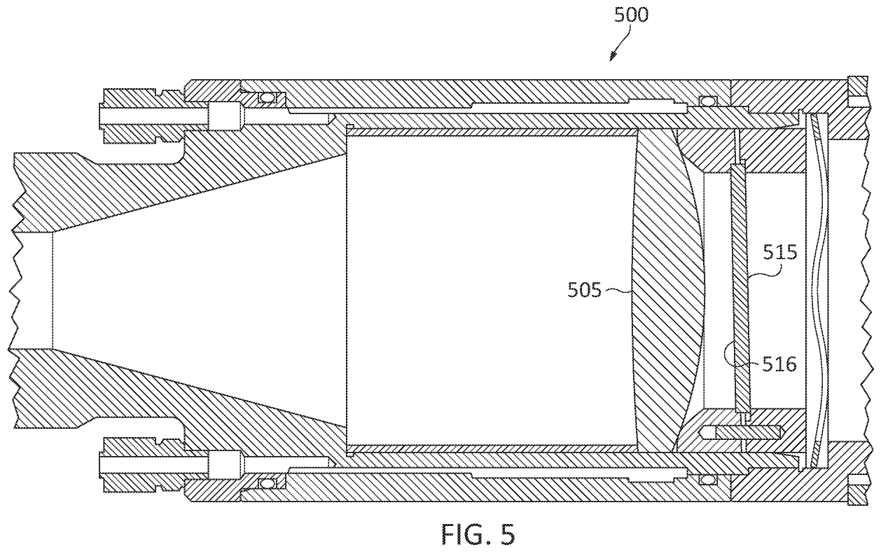

FIG. 5 illustrates a top view of a collimation assembly 500 including a window 515 to receive laser light to reflect light having a selected wavelength along a different axis than the laser light is received, according to various embodiments. The window 515 may be glass or some other transparent material. A treatment may be applied to a surface 516 of the window 515, and the treatment may be similar to any treatment described herein (e.g., the treatment of surface 116 of FIG. 1). In this example, the surface 516 may be located on an input side of the window 515, but in other examples the treatment may be located on an output side of the window 515.

In this example, the collimation assembly 500 includes a single lens 505. Other examples of a collimation assembly may include any number of lenses. In this example, the window 515 is located downstream of the single lens 505, but in other examples a window may be provided downstream of a last lens in examples in which there is more than one lens. In yet other examples, the window 515 may be located upstream of some or all lens(es) of a collimation assembly, between lenses, or the like, or any combination thereof.

In other examples, instead of a window, a treatment may be applied to an optical surface of at least one lens of a collimation assembly. In such an example, the treated surface of the lens of the collimation assembly may be arranged to receive laser light and reflect the light having the selected wavelength along an axis that is different than an axis along which the laser light is received. In other embodiments, a treatment may be applied to a partial reflector located in a collimation assembly (the partial reflector may be similar to the optical filter 315 of FIG. 3 in any respect).

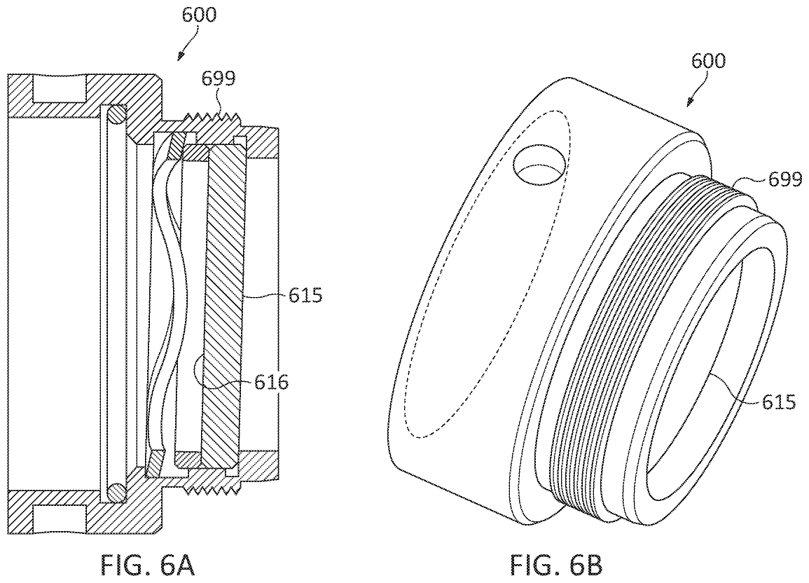

FIG. 6A illustrates a sectional view of a removably attachable accessory 600 for post laser suppression of undesired wavelengths in a laser system, according to various embodiments. FIG. 6B illustrates an isometric view of the removably attachable accessory 600 of FIG. 6A. The accessory 600 includes a window 615 with a surface 616, which may be similar in any respect to the window 515 and the surface 516 described with respect to FIG. 5. The accessory 600 includes threading 699 for mating with a threaded opening in a fiber system component, such as a collimation assembly.

In various embodiments, the accessory 600 may be interchangeable with another accessory that may be similar in any respect to the accessory 600 except that it may include an optical filter arranged to optically process a different selected wavelength or a dust shield window, which may be a window with AR coatings only and/or other surface(s) arranged to pass all the received laser light.

In various embodiments, the window 515 may be arranged to receive laser light along a first axis and reflect one of the undesired light or the remaining light over a second axis that may be non-parallel with the first axis. The other of the undesired light or the remaining light may be transmitted over a third axis, which may be parallel with the first axis. The second axis may be similar in any respect to the second axis described with respect to FIG. 1, and the third axis may be similar in any respect to the third axis described with respect to FIG. 1.

In any embodiment described herein, the optical filter may be any optical device such as a lens, a reflector, a face of a distal end of an optical fiber (such as an endcap splicable thereon), a window, or the like. The optical filter may be arranged for use in a fiber laser or any other laser system. The optical filter may be located at an initial air to optical interface of the laser system (such as at distal end of an optical fiber, such as the output face of an endcap corresponding to the optical fiber), in a collimation assembly of the laser system (e.g., at an exit aperture of the collimator), or downstream of the collimation assembly (such as in a process head or scanner system associated with the laser system).

The optical filter may include a surface located in a plane that intersects a plane that is orthogonal to an axis of the laser light. This surface may be treated with a coating or any other treatment, now known or later developed, that arranges the surface to optically process a selected wavelength of the laser light. The treated surface may have other coatings such as an AR (anti-reflection) coating and/or other surfaces of the optical filter may have an AR coating.

In various embodiments, the spectral proximity of a coating's reflective band (e.g., 1100-1150 nm-ish) to the transmissive band (e.g., 1060-1080 nm) may create technical challenges that can compromise the transmission and/or reflective efficiency. Therefore, some compositions/arrangements of the coating may be selected to strike a balance that may provide the desired suppression without significantly affecting transmission of the primary laser wavelength. In some embodiments, the coating may be arranged as follows:

### Coatings

Side 1: (HT>95%@1060-1080 nm+HR_avg>99.7%@1100-1200 nm
Side 2: AR<0.1%@1060-1080 nm,

In other applications that do not have the same maximum Raman content requirements, a non-Raman coated window may be provided in an accessory to operate as a dust shield for the internal optics of the collimation assembly. In these applications, the non-Raman coated window may have any characteristics of any window accessory described herein. In some embodiments, more than one accessory may be provided for the same laser system so that the laser system operator may switch between accessories (one with a Raman coated window, and one with a non-Raman coated window) depending on application requirements.

In various embodiments, a window or other optical filter corresponding to a collimation assembly may be tilted such that the reflected light completely misses the connector shield. This could work well for collimators with long focal lengths without a lot of double clipping at the aperture. The laser beam may hit the wall of the collimator at grazing incidence and spread the light over a wide region. It may then mostly reflect into the endcap, but the surface may scatter it enough to not have a tightly focused spot. In one example, with a 100 mm focal length the tilt may be 2.5°. For the short 40-70 mm focal lengths, the tilt may be greater than 1° so that double clipping will be large.

### Normal-Incidence (Non-Tilted) Optical Filters

In some embodiments, an optical filter may be located in a plane that is orthogonal to an axis along which the laser light is received. e.g., not tilted. In a diverging beam, the risk of a non-tilted optical filter reflecting Raman light (or light having some other selected wavelength) back into the fiber laser decreases as the distance from the distal end of the optical fiber to the surface of the non-tilted optical filter increases. Various embodiments of a collimation assembly may include a non-tilted window or other optical filter with a surface located in a plane that is orthogonal to an optical axis of the collimation assembly.

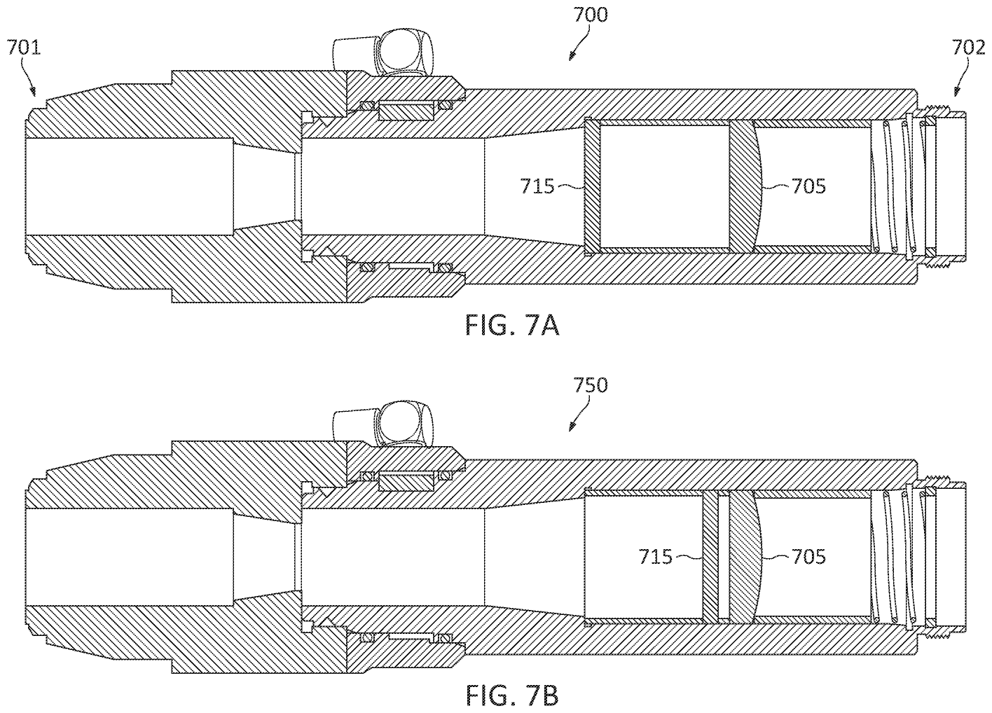

FIG. 7A illustrates a sectional view of a collimation assembly 700 for post laser suppression of undesired wavelengths in a laser system, according to various embodiments. The collimation assembly 700 may be used with a fiber laser including an optical fiber having a distal end to output a diverging beam to an input side 701 of the collimation assembly 700. The collimation assembly 700 includes a normal-incidence window 715, which may have a coating or other treatment similar to any treatment described herein to reflect a selected wavelength from the received beam (e.g., a treatment similar to a treatment applied to the surface 116 of FIG. 1). A distance between the collimation assembly 700 and the optical fiber (not shown) limits the amount of light that the normal-incidence window 715 may reflect back into a core of the optical fiber, which may avoid further amplification that can lead to undesirable laser performance or destruction results. In this embodiment, the normal-incidence window 715 may be located on a proximal side of the lens 705 on one end of an optical cavity containing the lens 705.

An output side 702 of the collimation assembly 700 may include threading or some other mechanical coupling interface to receive an accessory similar to any accessory described herein (e.g., accessory 600 of FIGS. 6A-B). In one example, the accessory may include a window (e.g., a tilted window or a normal-incidence window), which may operate similar to any optical filter described herein and/or may operate to environmentally isolate a free space optical such as the lens 705 or any other component insides the collimation assembly 700.

FIG. 7B illustrates a sectional view of another collimation assembly 750 for post laser suppression of undesired wavelengths in a laser system, according to various embodiments. In this embodiment, the normal-incidence window 715 is located next to the lens 705. In this location, the distance between the reflection location and the distal end of the optical fiber is even greater, which may further reduce the amount of light that the normal-incidence window 715 may reflect back into a core of the optical fiber as compared to collimation assembly 700 (FIG. 7A).

In view of the many possible embodiments to which the principles of the disclosed technology may be applied, it should be recognized that the illustrated embodiments are only preferred examples and should not be taken as limiting the scope of the disclosure.

1. An apparatus usable in a laser system, the apparatus comprising:
at least one optical filter to receive a laser beam or laser light along a first axis, the laser beam or laser light generated by the laser system, wherein the at least one optical filter is configured to:
reflect light having a selected wavelength along a second axis that is non-parallel with the first axis and pass the remainder of the laser light or laser beam along a third axis that is parallel with the first axis, or
transmit the light having the selected wavelength along the third axis and reflect the remainder of the laser light or laser beam along the second axis.

2. The apparatus of claim 1, wherein the light having the selected wavelength comprises Raman light, stimulated Raman scattering, Brillouin scattering, or combinations thereof.

3. The apparatus of claim 1, wherein the at least one optical filter is usable in a distal end of the laser system.

4. The apparatus of claim 3, wherein the at least one optical filter comprises an endcap splicable to a distal end of an optical fiber of the laser system.

5. The apparatus of claim 4, wherein the at least one optical filter comprises an output surface of the endcap.

6. The apparatus of claim 1, wherein the at least one optical filter comprises a lens, a reflector, a face of an optical fiber, a window, or combinations thereof.

7. The apparatus of claim 1, wherein the apparatus comprises a collimation assembly to receive the laser beam from an endcap of a distal end of the laser system, wherein the at least one optical filter is located in the collimation assembly.

8. The apparatus of claim 7, wherein the at least one optical filter comprises a window proximate to a lens of the collimation assembly.

9. The apparatus of claim 8, wherein the at least one optical filter comprises a planar surface of the window, and wherein the planar surface is located in a plane that intersects a plane that is orthogonal to the optical axis of the collimation assembly, wherein the planar surface comprises a proximal or distal surface of the window.

10. The apparatus of claim 7, wherein at least one optical filter is located in a pair of optical wedges.

11. The apparatus of claim 1, wherein the at least one optical filter comprises an initial air to optical interface downstream of a distal end of the laser system.

12. The apparatus of claim 1, wherein the at least one optical filter is a free space optic.

13. The apparatus of claim 1, wherein the apparatus comprises an accessory removably coupled to an output side of a collimation assembly, wherein the at least one optical filter comprises a window of the accessory.

14. The apparatus of claim 13, wherein the at least one optical filter comprises a surface of the window, wherein the surface is located in a plane that is non-perpendicular to the optical axis of the collimation assembly, wherein the surface comprises a proximal or distal surface of the window.

15. The apparatus of claim 13, wherein the accessory is mechanically coupled to the output side of the collimation assembly.

16. The apparatus of claim 13, wherein the apparatus comprises an additional accessory interchangeable with the accessory, wherein the additional accessory includes a window with no optical filter or an optical filter configured differently than the at least one optical filter.

17. The apparatus of claim 1, wherein the apparatus comprises a process head or a scanner, and wherein the at least one optical filter is located in the process head or the scanner.

18. The apparatus of claim 1, wherein the remainder of the laser light or laser beam includes wavelengths in the 1100-1150 nm range.

19. An optical assembly including a normal-incidence window comprising:
a surface to receive a diverging beam along an optical axis of the optical assembly, the diverging beam generated by the laser system, the surface located in a plane that is orthogonal to the optical axis of the optical assembly, wherein the surface is configured to:
reflect light having a selected wavelength from the diverging beam; and
pass the remainder of the diverging beam to an optical device of the optical assembly.

20. The collimation assembly of claim 19, further comprising an accessory mechanically coupled to a distal end of the optical assembly, wherein the accessory includes an additional window to environmentally isolate the optical device.
